(19) United States
(12) Patent Application Publication
(10) Pub. No.: US 2008/0175104 A1
(43) Pub. Date: Jul. 24, 2008

(54) FLEXIBLE ELECTRONIC CALENDAR INTEGRATING TASKS AND APPOINTMENTS

(75) Inventors: DOREEN GRIEB, KIRKLAND, WA (US); TODD HAUGEN, BELLEVUE, WA (US); MELINDA NASCIMBENI, SEATTLE, WA (US); JOHN E. KNAPP, SEATTLE, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 11/625,914

(22) Filed: Jan. 23, 2007

(51) Int. Cl. G04C 17/00

(52) U.S. Cl. 368/29; 368/28

(57) ABSTRACT

A flexible electronic calendar allows the integration of both items that have a specific time (e.g., appointments) and items that do not have a specific time (e.g., tasks) to be displayed within the context of the electronic calendar view, thereby allowing users to organize tasks in the context of scheduled appointments. An electronic calendar view is displayed. An appointment having a specific time is displayed within the electronic calendar view. Additionally, a task is displayed within the context of the electronic calendar view without setting a specific time for the task. The task is displayed at a user-specified location within the electronic calendar view.

### CROSS-REFERENCE TO RELATED APPLICATIONS

This application is related by subject matter to the invention disclosed in the commonly assigned application U.S. application Ser. No. (not yet assigned) (Attorney Docket Number MFCP. 131359), filed on even date herewith, entitled “ELECTRONIC CALENDAR ASSOCIATING TASKS AND APPOINTMENTS.”

### STATEMENT REGARDING FEDERALLY SPONSORED RESEARCH OR DEVELOPMENT

Not applicable.

### BACKGROUND

A variety of electronic calendaring solutions are available to assist users in planning and organizing their scheduled appointments and tasks. However, these electronic calendaring solutions are typically designed for the work environment. In particular, the solutions provide a rigid approach to calendaring. For example, items placed into a calendar view must be entered using an exact date and time. While this approach works well for scheduled items that have a specified start and end time (e.g., appointments), it is difficult to represent items that do not have a specific date and time (e.g., tasks or to-do items) in the context of the calendar view.

As a result, electronic calendaring solutions typically provide a task (or to-do) list that is separate from the calendar view. In some cases, a task list may be presented adjacent to the calendar view. In other instances, tasks may be associated with a particular date but are shown at the top of the day view. In any case, tasks (or other items that do not have a specified time) are not shown within the context of scheduled items within the calendar view indicating when a user may intend to perform the tasks.

This shortcoming of current electronic calendaring solutions makes it difficult for users to organize the completion of items without a specified time (e.g., tasks) within the context of items that do have a specified time (e.g., appointments). One way that some users have attempted to circumvent this problem is by entering tasks into calendar views by specifying a specific start and end time for the tasks, but this is an awkward approach. In essence, by specifying a specific time for the tasks, users are turning the tasks into appointments. However, the nature of tasks is that they are more flexible than appointments. In particular, users typically wish to complete tasks not at a specific time but at a more general time.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments relate to presenting an electronic calendar view in a flexible manner that allows the integration of both items that have a specific time (e.g., appointments) and items that do not have a specific time (e.g., tasks) within the context of the electronic calendar view. In an embodiment, an electronic calendar view is displayed. An appointment having a specific time is displayed within the electronic calendar view. Additionally, a task is displayed within the context of the electronic calendar view without setting a specific time for the task. The task is displayed at a user-specified location within the electronic calendar view.

### BRIEF DESCRIPTION OF THE SEVERAL VIEWS OF THE DRAWING

The present invention is described in detail below with reference to the attached drawing figures, wherein:

FIG. 1 is a block diagram of an exemplary computing environment suitable for use in implementing the present invention;

FIGS. 2A-2C are exemplary screen displays showing an electronic calendar view without a time scale allowing for the flexible representation of items within the context of the calendar view in accordance with an embodiment of the present invention;

FIGS. 3A-3F are exemplary screen displays showing an electronic calendar view having a time scale that may expand and contract based on the presence of items within the calendar view in accordance with an embodiment of the present invention;

FIG. 4 is a flow diagram showing an exemplary method for presenting an electronic calendar in accordance with an embodiment of the present invention;

FIG. 5 is a flow diagram showing an exemplary method for presenting an electronic calendar with a flexible time scale in accordance with an embodiment of the present invention;

FIGS. 6A and 6B are exemplary screen displays showing an electronic calendar view including a task having a before association with an appointment and movement of the task and appointment based on a change in scheduled time for the appointment in accordance with an embodiment of the present invention;

FIGS. 7A-7C are exemplary screen displays showing an electronic calendar view including tasks having an in-between association with two appointments and movement of the tasks and appointments based on changes in scheduled times for the appointments in accordance with an embodiment of the present invention

FIG. 8 is a flow diagram showing an exemplary method for associating a task with an appointment and moving the task relative to the appointment based on changes to a scheduled time for the appointment; and

FIG. 9 is an illustrative data structure used in embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

As previously mentioned, current electronic calendaring solutions provide a rigid approach to calendaring. In particular, calendar views of current electronic calendaring solutions include rigid time scales, and items are placed in the calendar views based on specific times associated with each item. This approach, however, precludes items that do not have a specific time or duration from being integrated within the calendar view at a general location indicating when a user may intend to perform or complete the item. As a result, it is difficult for users to determine the best way to organize items that do not have a specific time within the context of scheduled items.

Embodiments of the present invention relate to representing items in electronic calendars in a flexible manner. In particular, embodiments allow, among other things, items that do not have a specific time or duration associated with them to be shown within the context of an electronic calendar view in addition to items that do have a specific time, thereby allowing a user to organize all items within a common calendar view. Instead of requiring items to be placed at specific times within a calendar view, embodiments allow items to be placed at general times at which a user intends to complete the items.

As used herein, the term “appointment” is used to refer to any calendar item that has a specified time (e.g., a specified start time and a specified end time). These types of items are traditionally shown in electronic calendar views. Additionally, as used herein, the term “task” is used to refer to any calendar item that does not have a specific time or duration. Accordingly, a task includes any item, including a to-do, an event, or an occasion, that the user intends to address or complete at a general time, such as, for example, this morning, this afternoon, this evening, before another item, after another item, between two items, or during another item.

In accordance with various embodiments of the present invention, items may be placed within electronic calendar views without tying the items to a specific time scale. As a result, items are not required to be shown at specific locations within an electronic calendar view but instead may “float” within the calendar view. Additionally, a user may manually size and position items within the calendar view.

In embodiments, an item may be shown as a “chunk” of time that consumes a portion of the calendar view. Items shown as a chunk of time may be bounded without using specific time endpoints. In some cases, an item may be bounded by general but well-understood time endpoints. For example, a chunk of time for an item may be defined as sometime this morning, which has a meaning specific to the user, such as between when the user wakes up and before the user eats lunch. Additionally, a chunk of time for an item may be bounded by other items having known time endpoints. For example, a chunk of time for an item may be defined as being between two appointments. Further, a chunk of time for an item may be bounded by a combination of a general but well understood time endpoint and an item having a known time endpoint. For example, a chunk of time for an item may be defined as being sometime this morning before an appointment. By representing an item as a chunk of time, the item may be flexibly represented within the calendar view without setting a specific time for the item.

In some embodiments, a calendar view is provided without a specific time scale. Both appointments and tasks may be represented without tying the items to exact locations within the calendar view. In some embodiments, a calendar view is provided with a time scale that may be optionally displayed or hidden. Appointments are displayed within the calendar view based on associated scheduled times, while tasks are displayed based on a general time a user intends to complete the task without assigning a specific time to the tasks and without requiring the tasks to be displayed at a specific location in the calendar view based on the time scale. In embodiments in which a time scale is displayed for the electronic calendar view, the time scale may expand and contract based on the presence of items within the calendar view.

In further embodiments of the present invention, tasks may be associated with appointments and displayed within an electronic calendar view based on the associations. An association between a task and an appointment reflects when a user intends to perform the task relative to the appointment. For example, a user may wish to perform a task before, during, or after a scheduled appointment. The task is shown in the electronic calendar view based on the association. Additionally, if the scheduled time for the appointment changes, the task is moved with the appointment.

Accordingly, in one aspect, an embodiment of the present invention is directed to computer-readable media embodying computer-useable instructions for performing a method of presenting an electronic calendar. The method includes displaying an electronic calendar view. The method also includes displaying at least one appointment having a specific time within the electronic calendar view. The method also includes displaying at least one task within the context of the electronic calendar view without setting a specific time for the task. The task is displayed at a user-specified location within the electronic calendar view.

In another embodiment, an aspect of the invention is directed to computer-readable media embodying computer-useable instructions for performing a method of presenting an electronic calendar. The method includes displaying an electronic calendar view including a time scale. The method also includes adjusting the time scale based on the presence of one or more items in the electronic calendar view.

In a further aspect of the invention, an embodiment is directed to a device having a processor and computer-readable media including instructions for causing the processor to perform a method comprising displaying an electronic calendar view. The electronic calendar view includes one or more items not having a specific time. Each of the items are displayed within the context of the electronic calendar view at a user-specified location based on a general time a user intends to complete each of the items.

### Exemplary Operating Environment

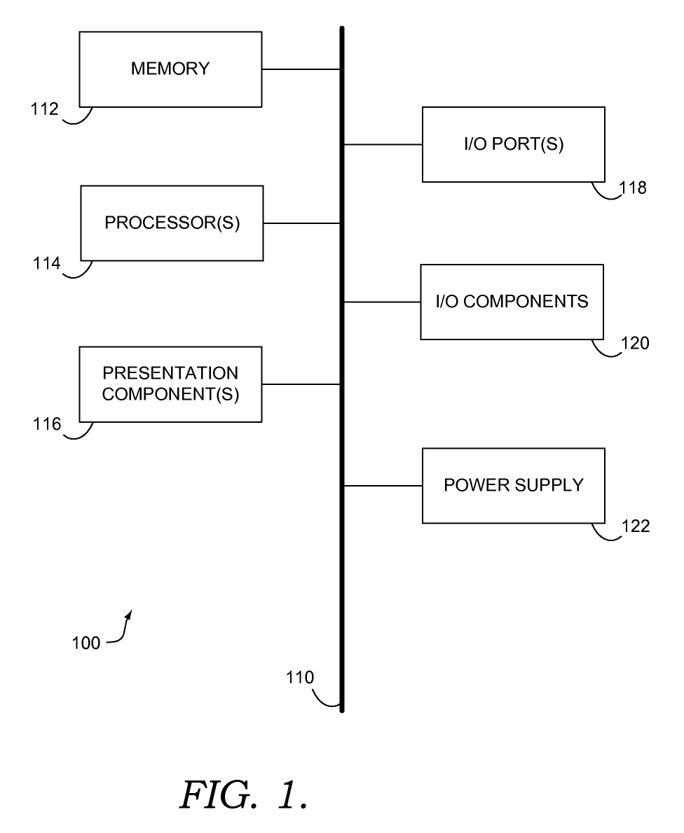

Having briefly described an overview of the present invention, an exemplary operating environment in which various aspects of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

### Representing Items in the Calendar as Chunky Time

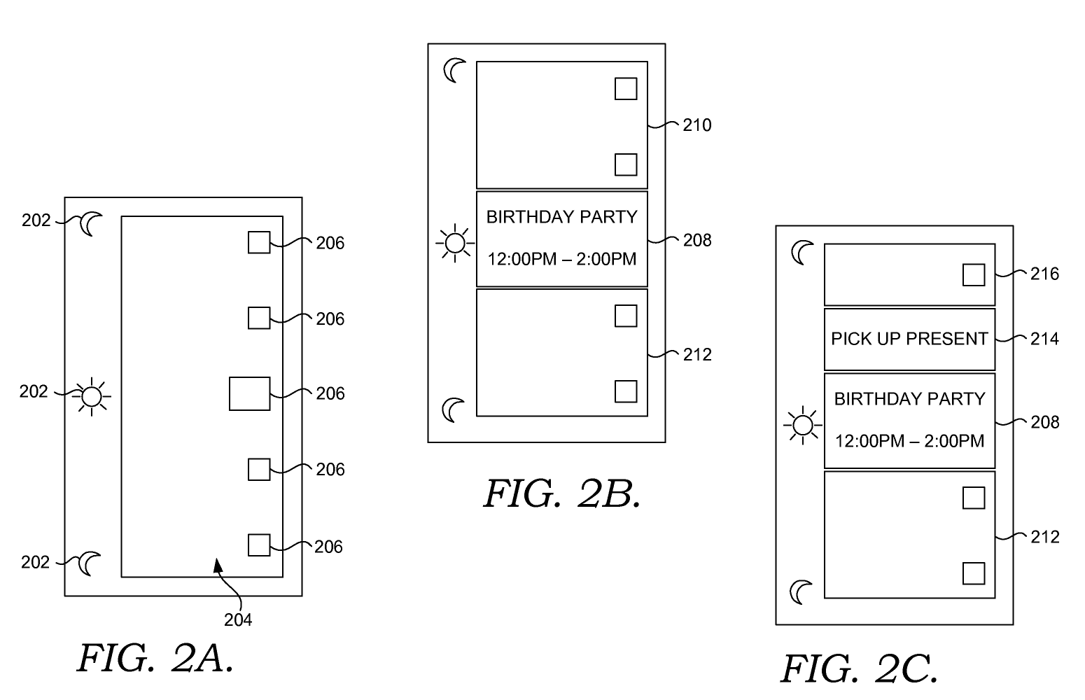

Turning now to FIG. 2A through FIG. 2C, exemplary screen displays are provided showing a day view of a calendar in accordance with an embodiment of the present invention. In particular, the calendar shown in FIG. 2A through FIG. 2C is an embodiment in which the day view does not have a specific time scale and items placed in the day view are represented as chunks of time. By representing each item as a chunk of time, items are shown as consuming a portion of the day view. Additionally, each item may or may not have a specified time associated with the item. Because the day view of the present embodiment does not include a time scale, appointments may be represented flexibly within the day view. In particular, the size and location of an appointment is not dictated by a rigid time scale, but may be adjusted by a user. Additionally, users may add tasks to the day view at locations corresponding with a general time at which the users intend to complete the tasks.

Referring initially to FIG. 2A, a day view is shown prior to any items being placed within the view. In the day view, the top of the area may be considered morning, the middle of the area may represent afternoon, and the bottom of the area may represent evening. In some embodiments, symbols, such as symbols 202 in FIG. 2A, may be included to provide a general indication of what each area of the view represents. In other embodiments, no symbols may be provided.

As indicated previously, FIG. 2A illustrates a day view before any items have been placed within the view. Accordingly, the day view is shown with one chunk of free time 204. A number of suggestion areas 206 are also shown within the day view. The suggestion areas 206 represent areas suggested for the placement of appointments and tasks within the day view. For example, a user may select a suggestion area 206 near the top of the day view if the user wishes to add either an appointment scheduled for the morning or a task the user wishes to complete in the morning.

It should be noted that while the embodiment shown in FIG. 2A includes a chunk of free time 204 in a empty day view, in other embodiments, a day view without any items is simply shown as blank (i.e., without the chunk of free time 204). Additionally, while the embodiment shown in FIG. 2A includes suggestion areas 206, in other embodiments, no suggestion areas are provided and a user may simply select any area of the day view to enter an item. Any and all such variations are contemplated to be within the scope of embodiments of the present invention.

When a user adds an appointment to the day view by selecting a suggestion area 206 or by selecting a general area of the day view, a time may be given to the appointment that most closely represents the area selected by the user. For example, referring to FIG. 2B, the user has selected an area corresponding with the middle of the day to add an appointment 208, representing a birthday party. When the appointment 208 is added, the free time divides into two chunks of time 210, 212. Additionally, the appointment is assigned start and end times based on the area selected by the user for placement of the appointment. If necessary, the user may then manually select the appointment item and adjust the time to correspond with the appointment's actual scheduled start and end times.

Alternatively, a user may select to add an appointment and specify the start and end times prior to placement of the appointment in the day view. The appointment is then shown in the day view based on the specified times. For example, the user may have selected to add an appointment, provided a description “Birthday party,” and provided a start time of 12:00 pm and an end time of 2:00 pm for the appointment. The appointment is then added at a general area of the day view corresponding with the specified times.

In prior art electronic calendar solutions, a rigid time scale (e.g., an hourly scale) requires the size of the appointment to correspond with its start and end times. In contrast, by not including a rigid time scale in the present embodiment, a user may make the appointment 208 any size the user wishes without affecting the start and end times of the appointment 208. For example, the user may select either the top or bottom of the appointment 208 and drag the selected potion to resize the appointment 208 as is well known within the art. Additionally, the user may drag and drop the appointment to a different location within the day view. The start and end times may be unaffected by these actions.

To provide the user with an indication of the scheduled time for appointments, the text of an appointment in the day view may include the start and/or end times. For example, in FIG. 2B, the appointment 208 shows a start time of 12:00 pm and an end time of 2:00 pm. In other embodiments, however, the appointment may be shown in the day view without the scheduled times, but the user may access the scheduled times by selecting to view details of the appointment.

In addition to appointments that have a scheduled start and end time, a user may add tasks that do not have a scheduled time. Tasks may be added to the day view in any of a number of different ways, such as, for example, selecting a suggestion area within a day view, selecting any area within a day view, and dragging a task from a task list and dropping the task in the day view. FIG. 2C illustrates the day view of FIG. 2B after a task 214 has been added in the morning. In the present example, the user has added a task 214 to “pick up present” before the “birthday party” appointment 208.

When a task is added to a day view, the task may be arbitrarily sized. The user may then resize the task to represent any chunk of time within the view that has meaning to the user. For example, the task 214 shown in FIG. 2C is shown such that it consumes a chunk of midmorning time before the appointment 208 and after an earlier chunk of free time 216. The user may represent the task in this manner to indicate that the user wishes to perform the task midmorning. Alternatively, the user may size the task 214 such that it takes up all the space within the day view before the appointment 208 (i.e., there would be no chunk of free time 216). The user may wish the task to be represented in this manner, for example, if the user wishes to accomplish the task any time in the morning before the appointment 208.

By not including a rigid time scale, items may be placed at a location in the day view and sized according to the user's wishes to represent a chunk of time that has some meaning to the user. For example, task items may be placed above and below each other, potentially representing an order in which the user wishes to complete the tasks. Additionally, tasks may be placed side-by-side, potentially representing that the user wishes to complete the tasks simultaneously or that the order in which the tasks are completed is irrelevant. Further, the representation of appointments within the day view is not fixed by a rigid time scale. For example, a user may have two adjacent appointments (i.e., a first appointment with an end time that matches the start time of a second appointment). However, the user may wish to complete a task in between the appointments. In embodiments of the present invention, a user may place a task between the appointments and space may be provided between the appointments in the day view to allow for the representation of the task. Accordingly, embodiments allow for the flexible representation of items (both appointments and tasks) by not requiring the items to be tied to a rigid time scale.

Flexible Calendar View with Time Scale

In embodiments of the present invention, calendars may be provided with a time scale but may be flexible to allow for the integration of tasks that do not have scheduled times. The time scale associated with a calendar may be selectively hidden or displayed within the calendar view. Appointments are shown in the calendar view based on scheduled times, while tasks are shown in the calendar view independent of the time scale.

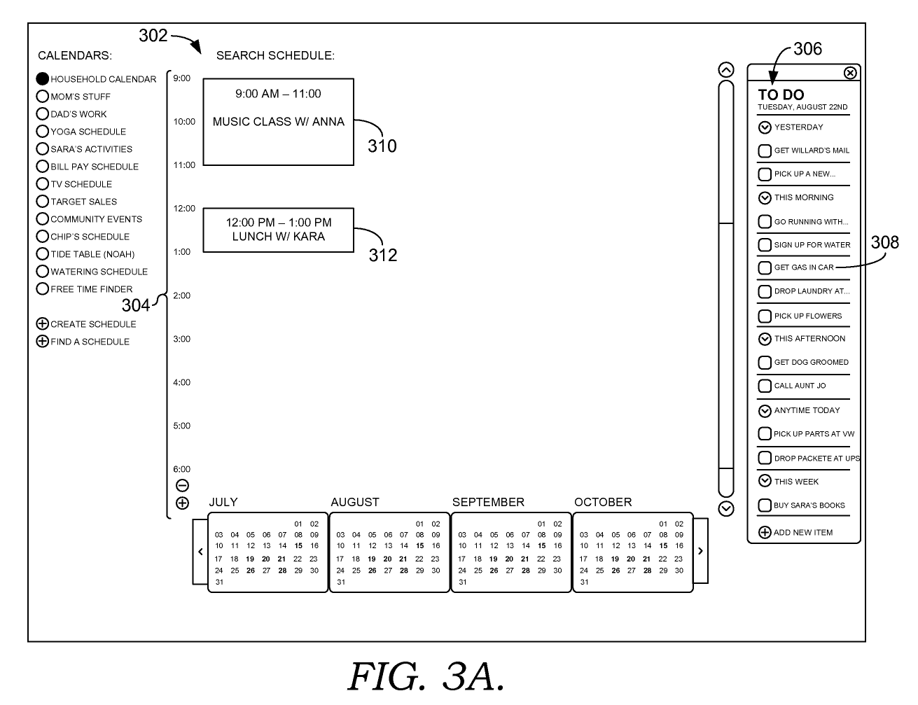

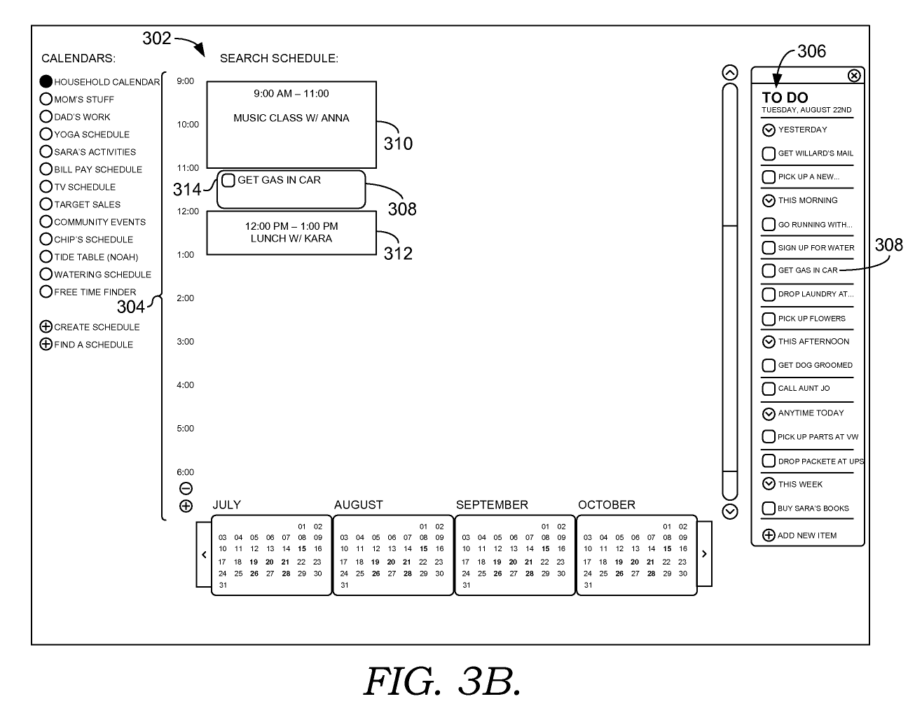

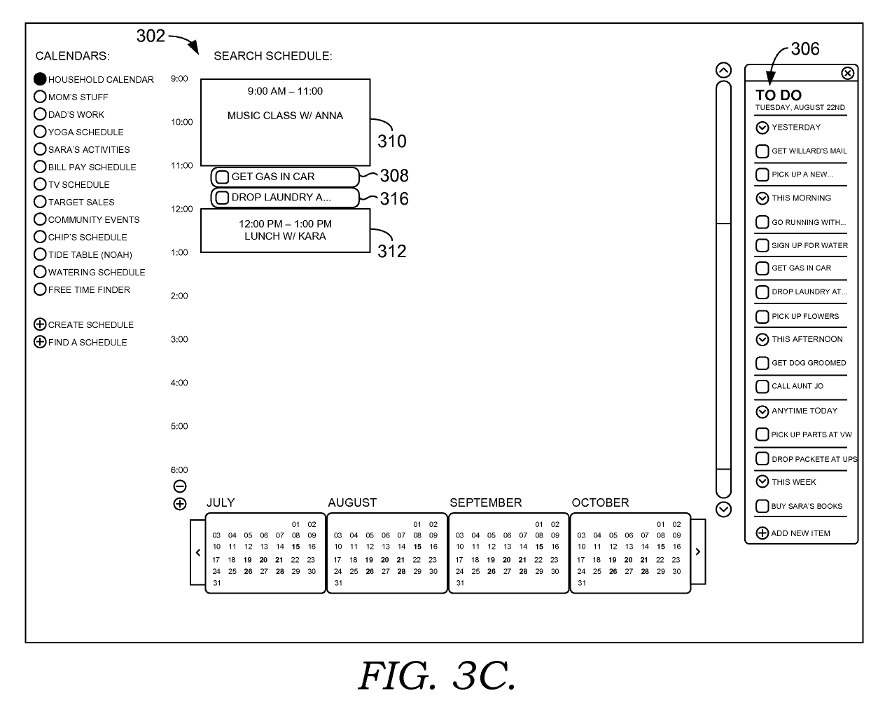

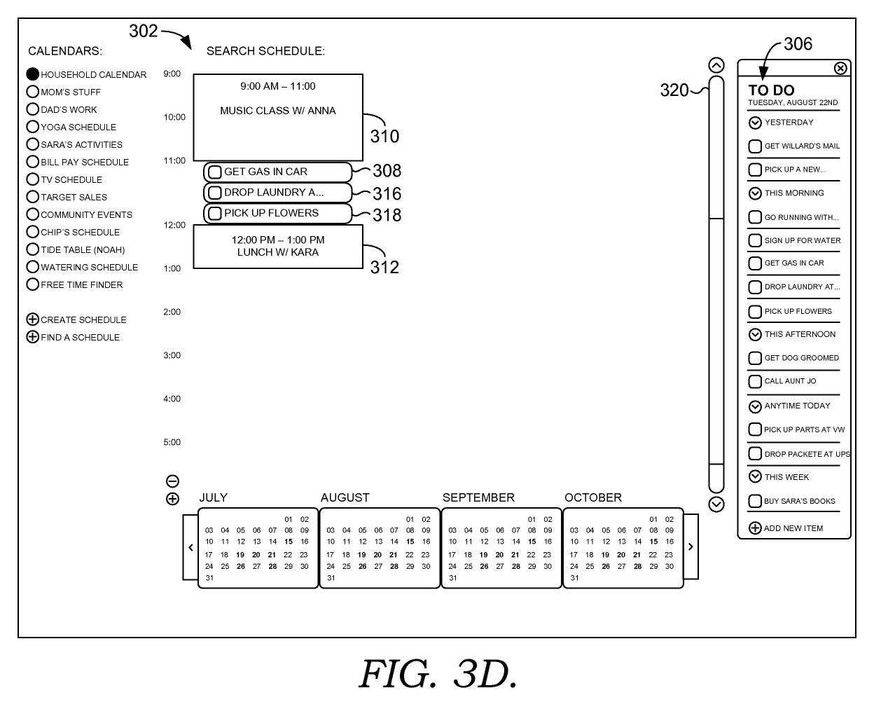

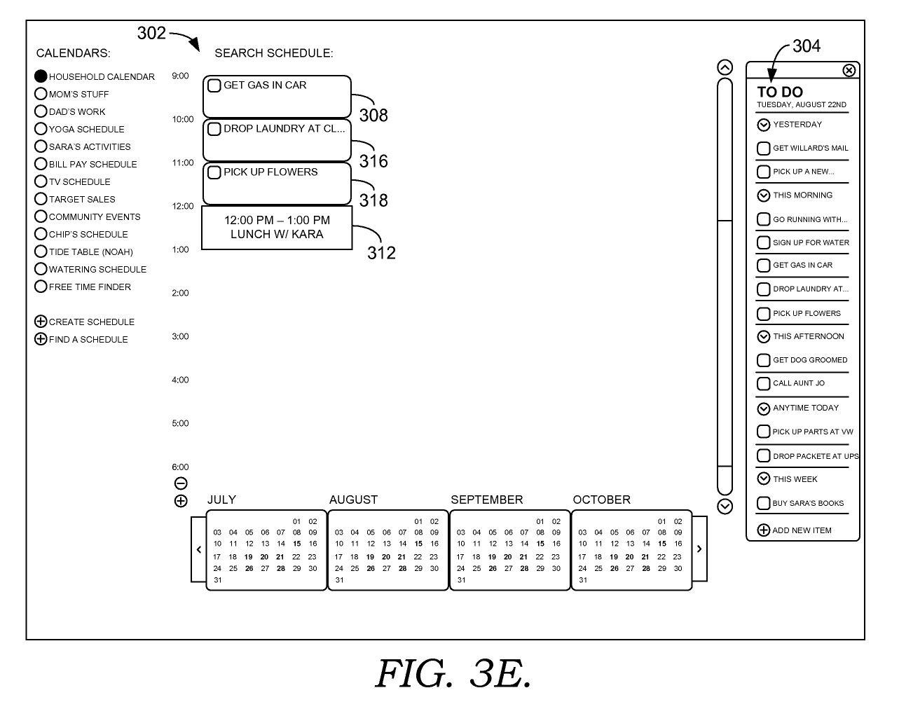

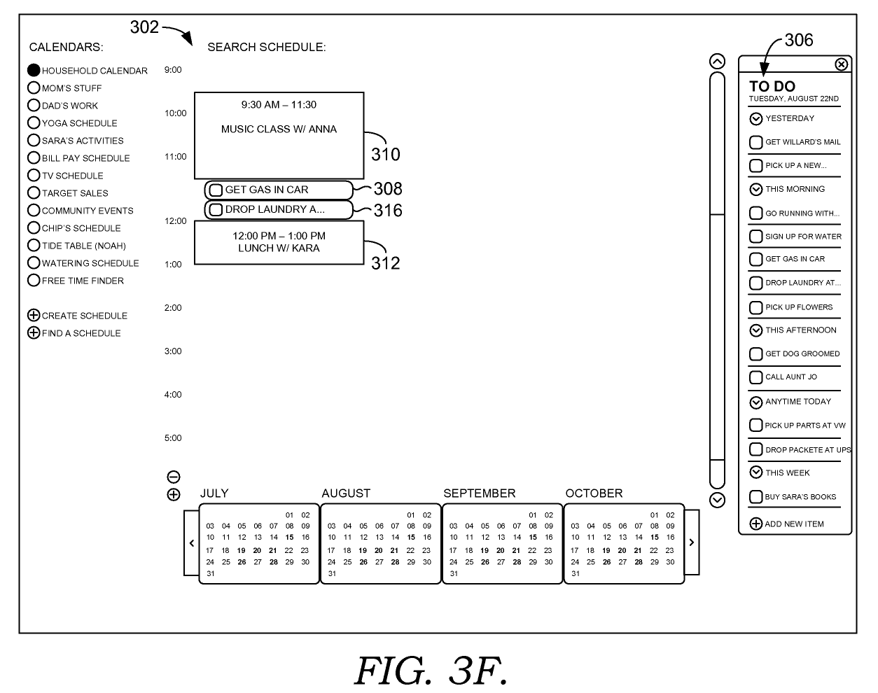

Referring initially to FIG. 3A, a screen display is provided illustrating an electronic calendar solution having a day view 302 including a time scale 304 and a task list area 306 that includes tasks separated into chunks of time. As shown in FIG. 3, tasks included in the task list area 306 are grouped into common chunks of time, such as “Yesterday,” “This Morning,” “This Afternoon,” “Anytime Today,” and “This Week.” By representing the tasks in this manner, the user may specify a chunk of time in which the user wishes to compete each task and view these chunks of time in context of scheduled appointments.

As shown in FIG. 3A, the day view 302 includes appointments 310 and 312 which are located within the day view based on their respective scheduled times. A user may also add tasks to the day view 302 without providing a specific time for the tasks. For example, the user may drag the task 308 in FIG. 3A and drop the task at an area in between the appointments 310 and 312. The task 308 may then be represented in the day view 302 between the appointments 310 and 312 as shown in FIG. 3B. In some embodiments, when a task is moved from the task list area 306 to the day view 302, the task is no longer represented in the task list area 306, while in other embodiments the task may be represented in both the day view 302 and the task list area 306.

It should be noted that although the task 308 is shown in FIG. 3B in the day view 302 which has a time scale 304, the task 308 does not have a scheduled start and end time. Instead, its presence in the day view 302 merely represents a general indication of when the user may wish to compete the task 308. For example, the task 308 is “Get gas in car,” which may only take five minutes. However, the task 308 is shown in the day view 302 in a manner to represent that the user wishes to complete the task 308 at any time during a general chunk of time. Accordingly, the task 308 may be represented as any arbitrary size automatically determined by the system or may be manually sized by the user to provide a meaning relevant to the user. The size and location of the task is independent of the time scale. In other words, whereas an appointment is positioned based on its scheduled time and the time scale increments, a task may be positioned freely from the time scale increments. For example, the appointment 310 has a start time of 9:00 am and an end time of 11:00 am such that its representation “snaps” to the corresponding 9:00 am and 11:00 am time scale increments in the day view 302. In contrast, because the task 308 does not have any scheduled time, it may be positioned in the calendar view independent of the time scale increments.

In some embodiments, tasks may have a visual representation in the calendar view that is different than the representation of appointments. By way of example only and not limitation, tasks may be represented using a different color or shape. Additionally, in some cases, tasks may be represented in the calendar view with a check box (such as the check box 314 in FIG. 3B), allowing a user to quickly select the check box when a task has been completed.

In some cases, when a user adds or removes tasks and/or appointments, tasks may be resized to accommodate for the addition or removal of items. For example, as shown in FIG. 3C, when a user adds an additional task 316 between the appointments 310 and 312, the task 308 may be resized to allow for the representation of the new task 316. Alternatively, the tasks 308 and 316 may be shown side-by-side in the day view 302. Again, the user may position and size the tasks 308 and 316 in a manner such that the representation has a meaning that is relevant to the user.

In other cases, the time scale in the calendar view may dynamically expand or contract based on the addition, deletion, and movement of items within a calendar view. FIG. 3D provides an example in which the addition of a task causes the expansion of the time scale. In particular, the user has added a third task 318 between the appointments 310 and 312. As a result, the time scale between 11:00 am and 12:00 am has expanded to provided space for the representation of the additional task 318. Although the remaining time scale has remained constant in the embodiment shown in FIG. 3D, in other embodiments, the time scale for the entire period (e.g., the day) may expand. As a time scale expands, the user may employ the scroll bar 320 to view details of various portions of the day.

The removal or movement of a task to another location may cause a time scale to contract. For example, if the user were to delete the task 318 in FIG. 3D, the time scale between 11:00 am and 12:00 pm that previously expanded would contract to again provide the representation shown in FIG. 3C

The addition, deletion, and movement of appointments may also cause a time scale to expand or contract. FIG. 3E provides an example in which the deletion of an appointment results in the contraction of the time scale. In particular, the user has deleted the appointment 310 (or otherwise moved the appointment 310 to another day) from the view in FIG. 3D. As a result, the time occupied by the appointment is now available to complete any of the tasks 308, 316, and 318, and the area corresponding with that time may be used for the representation of the tasks. Accordingly, the time scale between 11:00 am and 12:00 pm that previously expanded contracts back to its original size.

As a further example, suppose that the user reschedules the appointment 310 in FIG. 3C from start/end times of 9:00 am/11:00 am to start/end times of 9:30 am/11:30 am. The rescheduling of the appointment 310 may cause the time scale to expand as shown in FIG. 3F. In particular, the appointment 310 has moved closer to the second appointment 312 while the two tasks 308 and 316 have remained between the appointments. As such, the time scale between 11:00 am and 12:00 pm has expanded to provide space for the representation of each of the items.

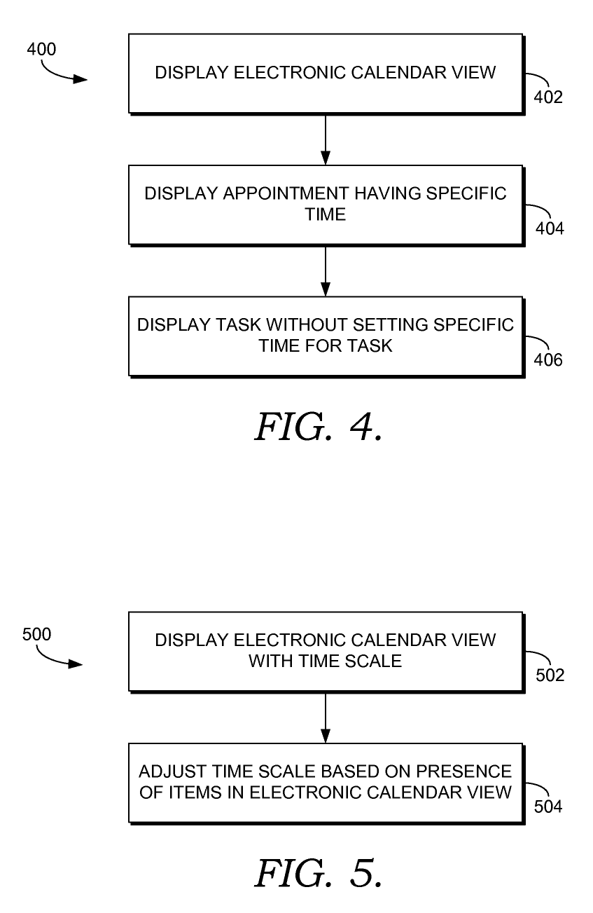

Referring now to FIG. 4, a flow diagram is provided illustrating an exemplary method 400 for presenting an electronic calendar in accordance with an embodiment of the present invention. As shown at block 402, an electronic calendar view is displayed. The electronic calendar view may be any type of calendar view, including, for example, a day view, a week view, a month view, and a year view. In some embodiments, the calendar view does not have an associated time scale. In other embodiments, the calendar view has an associated time scale, which may be selectively displayed or hidden.

An appointment is displayed in the electronic calendar view, as shown at block 404. The appointment has a specified time (e.g., a specific start time and a specific end time). In embodiments in which the calendar view does not have an associated time scale, a user may selectively size and position the appointment within the calendar view independent of the specified time for the appointment. In embodiments in which the calendar view has an associated time scale, the appointment is displayed within the calendar view based on its specified time.

As shown at block 406, a task is also displayed in the electronic calendar view. The task does not have a specific time and is displayed at a user-specified location within the calendar view. In embodiments in which the calendar view has an associated time scale, the task is displayed in the electronic calendar view independent of the time scale.

Turning now to FIG. 5, a flow diagram is provided showing an exemplary method 500 for presenting an electronic calendar with a flexible time scale in accordance with an embodiment of the present invention. As shown at block 502, an electronic calendar view is displayed with a time scale. The time scale is adjusted based on the presence of items in the electronic calendar view, as shown at block 504. In particular, the time scale may expand as necessary when items are added to or moved within the electronic calendar view. Additionally, the time scale may contract when items are removed from or moved within the electronic calendar view.

Associating Tasks with Appointments in the Calendar

People often complete tasks in relation to scheduled appointments. For example, a person way wish to drop off dry cleaning on the way to a meeting or may wish to do grocery shopping after picking up kids from a music lesson. Accordingly, in further embodiments, tasks may be associated with appointments in the calendar view. In some cases, a task may be associated with a single appointment, such as before, after, or during an appointment. In other cases, a task may be associated with multiple appointments, such as between two appointments. A task that is associated with one or more appointments is shown in the calendar based on its association with the appointment(s). If an appointment is moved, any associated tasks may be moved based on an association with the appointment.

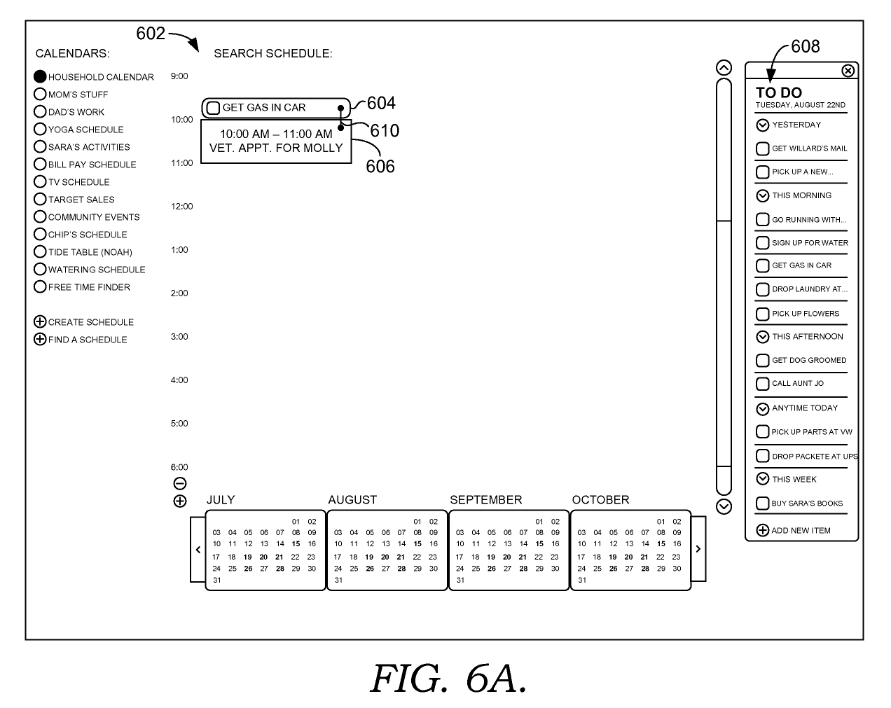

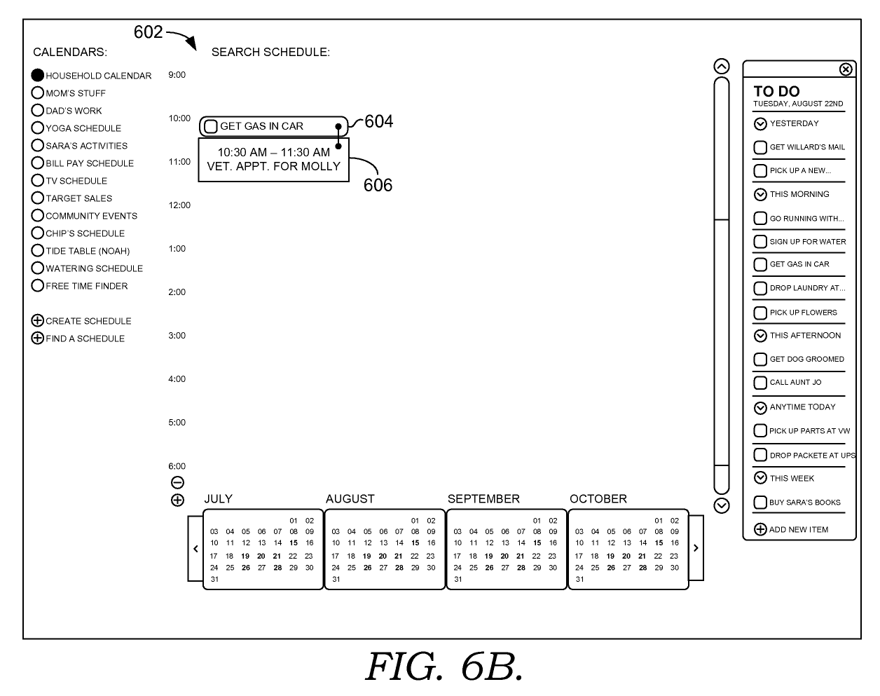

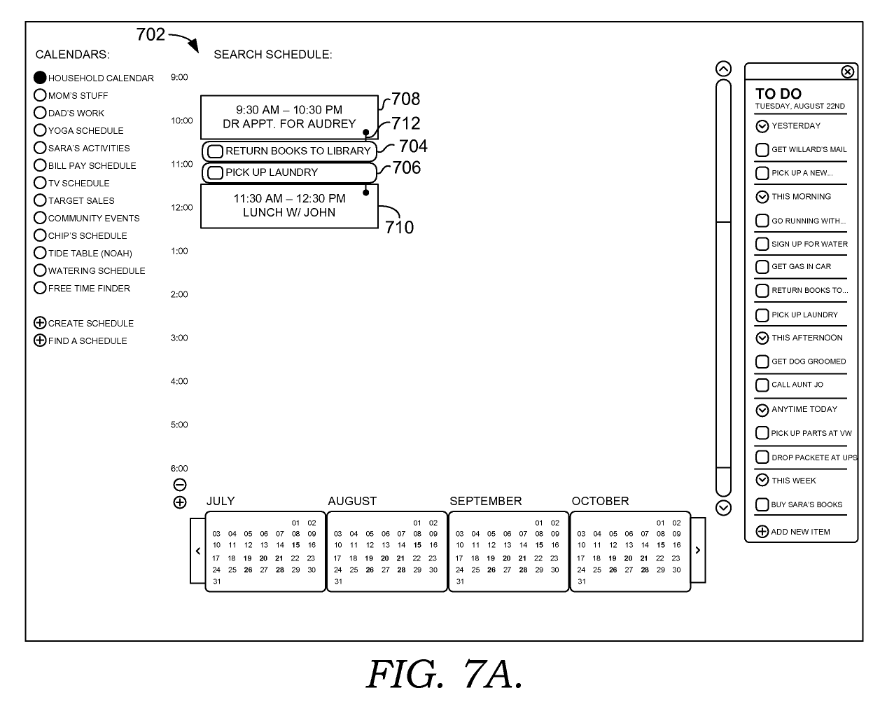

Referring to FIG. 6A, an exemplary screen display is provided illustrating a day view 602 including a task 604 that has a before association with an appointment 606. In the present example, the user wishes to stop at a gas station to get gas in his/her car on the way to a veterinary appointment. Accordingly, the user has associated the task 604 with the appointment 606 using a before association. Based on the before association, the task 604 is represented in the calendar view before the appointment 606.

An association between a task and an appointment may be created in a variety of different manners within the scope of the present invention. By way of example only and not limitation, in an embodiment, a user may drag a task from the task list area 608 and drop the task adjacent an appointment, thereby creating an association between the task and appointment. The type of association (e.g., before, during, after) may be based on the location relative the appointment at which the task was dropped.

In some embodiments, a visual indication may be provided to show an association between a task and an appointment. For example, in FIG. 6A, an association line 610 is provided showing the before association between the task 604 and the appointment 606. It should be noted that the task 604 shown in FIG. 6A may be sized in a variety of different manners in accordance with various embodiments of the invention. For example, the task 604 may have a predetermined size such as that shown in FIG. 6A that has little meaning other then to represent the item as a task in the calendar view. In other embodiments, the user may size the task 604 in a manner that has meaning to the user. In further embodiments, the task 604 may be sized to fill the available free time before the appointment 606. For example, the task 604 may be sized to fill the area in the day view 602 preceding the appointment 606.

As indicated previously, a task may be moved in a calendar view based on the movement of an associated appointment. For example, as shown in FIG. 6B, if the appointment 606 were moved from a start time of 10:00 am to a start time of 10:30 am, the task 604 is accordingly moved in the calendar view maintaining the before association with the appointment 606.

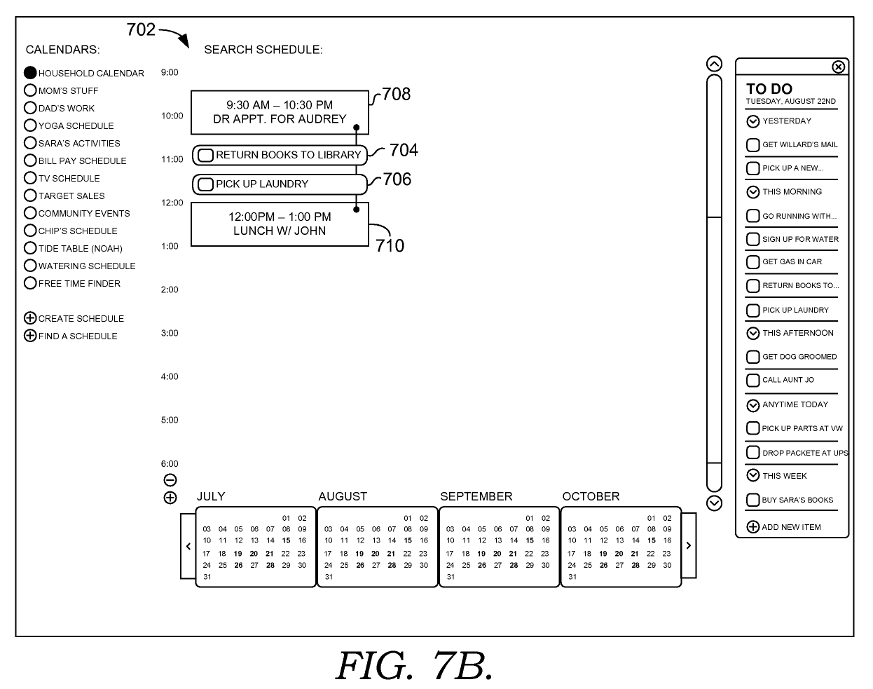

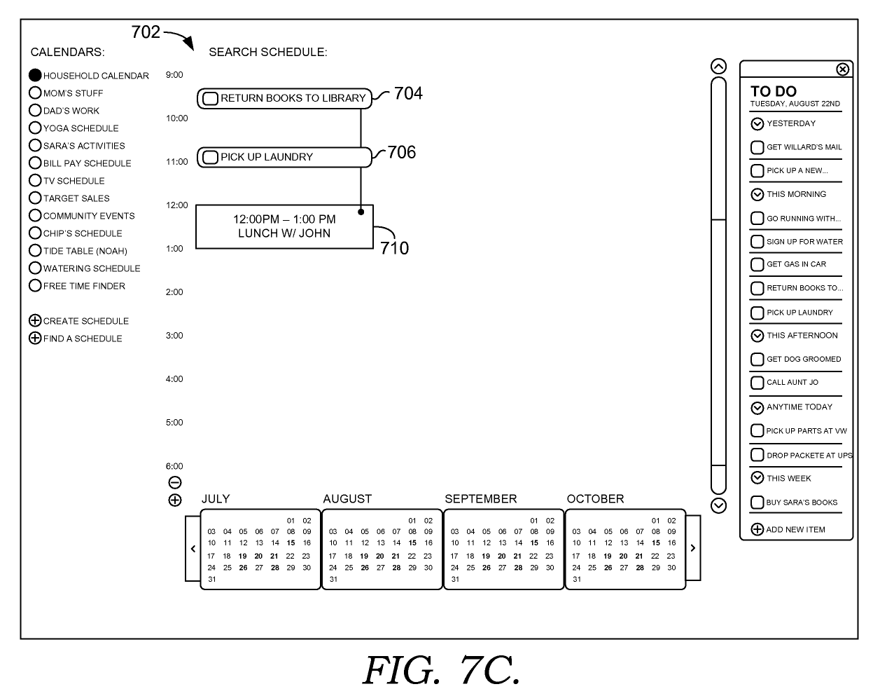

Referring now to FIG. 7A, an exemplary screen display is provided illustrating a day view 702 including tasks that have an in-between association with two appointments. In particular, the tasks 704 and 706 each have an in-between association with the appointments 708 and 710. The in-between association in FIG. 7A is visually represented using the association line 712. In embodiments, the in-between association between a task and two appointments comprises an after association between the task and an earlier appointment and a before association between the task and a later appointment. For instance, the task 704 may have an after association with the appointment 708 and a before association with the appointment 710.

If either of the appointments 708 and 710 are moved, the association between the appointments 704 and 706 and the tasks 708 and 710 may be maintained. For example, FIG. 7B illustrates a screen display after the appointment 710 has been moved from a start time of 11:30 to a start time of 12:00. As shown in FIG. 7B, the in-between association is maintained after the appointment 710 has been moved.

In some cases, an appointment may be canceled or moved to another day resulting in a change in an association. For example, in the screen display of FIG. 7C, the appointment 708 from FIG. 7B has been canceled. As a result, the in-between association for the tasks 704 and 706 is no longer valid. However, the tasks 704 and 706 may maintain an association with the existing appointment 710. In particular, the tasks 704 and 706 now have a before association with the appointment 710. Additionally, the tasks are now shown in a manner that indicates to the user that the tasks may be completed any time before the appointment 710 (including the time that was previously occupied by the appointment 708).

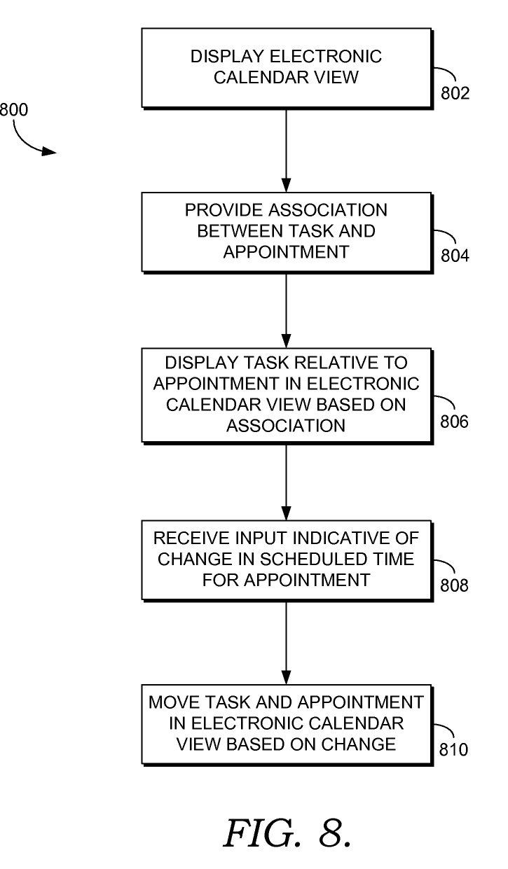

Referring now to FIG. 8, a flow diagram is provided showing an exemplary method 800 for associating a task with an appointment and moving the task relative to the appointment based on any changes to the appointment. As shown at block 802, an electronic calendar view is displayed. At block 804, an association is provided between a task and appointment to be displayed within the electronic calendar view. As indicated previously, the association represents when a user intends to perform the task relative to the appointment and may include a before association, a during association, and an after association. As shown at block 806, the task and appointment are displayed in the electronic calendar view with the task being displayed relative to the appointment based on the association.

In some cases, the scheduled time for the appointment may be changed. Accordingly, input indicative of a change in the scheduled time for the appointment is received, as shown at block 808. Typically, the association between the appointment and the task will be maintained after receiving the change to the appointment. Accordingly, the appointment and task are both moved to a new location in the electronic calendar view based on the change in the scheduled time for the appointment, as shown at block 810.

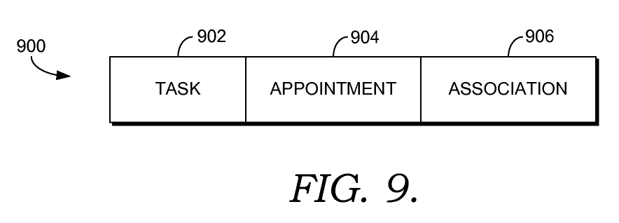

Some embodiments of the present invention utilize a data structure 900 illustrated in FIG. 9. The data structure includes a first data field 902 that contains data representing a task, a second data field 904 that contains data representing an appointment, and a third data field 906 that contains data representing an association between the task and the appointment. The association represents when a user intends to perform the task relative to the appointment. Accordingly, the association may represent, for instance: a before association in which the user intends to perform the task before the appointment, a during association in which the user intends to perform the task during the appointment; or an after association in which the user intends to perform the task after the appointment.

In various embodiments of the present invention, the first data field 902, the second data field 904, and the third data field 906 may have multiple entries. For instance, in some embodiments, the first data field 902 may contain data representing multiple tasks while the second data field 904 contains data representing a single appointment and the third data field 906 contains data representing a single association. This may allow for the representation of multiple tasks having a similar association with a common appointment (e.g., two tasks may both have a before association with a particular appointment). In some embodiments, the second data field 904 may include data representing multiple appointments, while the first data field 902 contains data representing a single task and the third data field 906 contains data representing a single association. This may allow for the representation, for instance, of a task having an in-between relationship with two appointments. In other embodiments, the third data field 906 may contain data representing multiple associations, while the first data field 902 contains data representing a single task and the second data field 904 contains data representing a single appointment. This may allow for the representation, for instance, in which a user wishes to perform a task either before or after an appointment. Any and all such variations are contemplated within the scope of embodiments of the present invention.

As can be understood, embodiments of the present invention provide a flexible electronic calendar that integrates tasks that do not have a specific time and appointments having a specific time in a common electronic calendar view. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer-readable media embodying computer-useable instructions for performing a method of presenting an electronic calendar, the method comprising:
displaying an electronic calendar view;
displaying at least one appointment within the electronic calendar view, the at least one appointment having a specific time; and
displaying at least one task within the context of the electronic calendar view without setting a specific time for the at least one task, the at least one task being displayed at a user-specified location within the electronic calendar view.

2. The one or more computer-readable media of claim 1, wherein the at least one appointment is selectively sized and positioned within the electronic calendar view independent of the specific time associated with the at least one appointment.

3. The one or more computer-readable media of claim 1, wherein the electronic calendar view has a corresponding time scale, and wherein the time scale is selectively displayed or hidden.

4. The one or more computer-readable media of claim 1, wherein the electronic calendar view comprises a day view.

5. The one or more computer-readable media of claim 4, wherein displaying the electronic calendar view comprises displaying the day view with a visible time scale.

6. The one or more computer-readable media of claim 5, wherein the specific time for the at least one appointment comprises a start time and an end time, and wherein the at least one appointment is displayed in the day view with the start time and the end time at corresponding times in the visible time scale.

7. The one or more computer-readable media of claim 5, wherein the at least one task is displayed in the day view independent of the visible time scale.

8. The one or more computer-readable media of claim 1, further comprising displaying a task list adjacent the electronic calendar view, the task list including one or more tasks.

9. The one or more computer-readable media of claim 8, wherein displaying at least one task within the electronic calendar view comprises receiving user input indicative of a selected task from the task list and placement of the selected task in the electronic calendar view.

10. The one or more computer-readable media of claim 1, further comprising displaying one or more free time items, the one or more free time items consuming a remainder of the electronic calendar view.

11. The one or more computer-readable media of claim 10, wherein the one or more free time items include a visual indication of at least one suggested area for the placement of an appointment or a task.

12. One or more computer-readable media embodying computer-useable instructions for performing a method of presenting an electronic calendar, the method comprising:
displaying an electronic calendar view, the electronic calendar view including a time scale; and
adjusting the time scale based on the presence of one or more items in the electronic calendar view.

13. The one or more computer-readable media of claim 12, wherein the electronic calendar view comprises a day view.

14. The one or more computer-readable media of claim 13, wherein the time scale of the day view includes hourly increments.

15. The one or more computer-readable media of claim 12, wherein adjusting the time scale based on the presence of one or more items comprises expanding at least a portion of the time scale based on the addition of one or more items in the electronic calendar view.

16. The one or more computer-readable media of claim 12, wherein adjusting the time scale based on the presence of one or more items comprises contracting at least a portion of the time scale based on the removal of one or more items in the electronic calendar view.

17. The one or more computer-readable media of claim 12, wherein adjusting the time scale based on the presence of one or more items comprises expanding at least a portion of the time scale based on the movement of one or more items within the electronic calendar view.

18. The one or more computer-readable media of claim 12, wherein adjusting the time scale based on the presence of one or more items comprises contracting at least a portion of the time scale based on the movement of one or more items within the electronic calendar view.

19. A device having a processor and one or more computer-readable media including instructions for causing the processor to perform a method comprising displaying an electronic calendar view; and displaying one or more items not having a specific time, each of the one or more items being displayed within the context of the electronic calendar view at a user-specified location based on a general time a user intends to complete each of the one or more items.

20. The device of claims 19, wherein the device comprises at least one of a desktop computer, a laptop computer, and a handheld computer.
